(19) United States
(12) Patent Application Publication
(10) Pub. No.: US 2001/0022128 A1
(43) Pub. Date: Sep. 20, 2001

(54) Fretgroove

(76) Inventor: Marco Antonio Ferreira Cortes, Dallas, OR (US)

Correspondence Address: Marco Antonio Ferreira Cortes, PO Box 707, Dallas, OR, 97338, US

(21) Appl. No.: 09/839,338

(22) Filed: Apr. 20, 2001

Related U.S. Application Data
(60) Provisional application No. 60/185,433, filed on Feb. 28, 2000.

(51) Int. Cl. G10D 3/00

(52) U.S. Cl. 84/290

(57) ABSTRACT

A fingerboard for stringed musical instrument having a series of predetermined grooves located at every position in which a series of consecutive frets would have otherwise occurred, in accordance with a predetermined tonal scale, providing the facilities of a fretted fingerboard and maintaining the characteristics of a fretless fingerboard.

### CROSS-REFERENCE TO RELATED APPLICATIONS

This application claims the benefit of U.S. Provisional Application No. 60/185,433 filed on Feb. 28, 2000.

### BACKGROUND

1. Field of Invention

This invention relates to musical instruments, specifically to a tuning system for stringed musical instruments.

2. Description of Prior Art

Stringed musical instruments commonly are configured having a relatively narrow neck structure. The neck structure usually has an end at which the instrument strings are attached in such a manner as to permit adjusting the tension of the strings, and has another end affixed to a body on which a bridge or saddle is provided to secure the opposite ends of these strings. The neck generally has a structural portion having an exposed surface below the strings, which is the fingerboard.

The fingerboard is classified in two types: fretted type and fretless type. A fretted fingerboard has a series of ridges fixed across the fingerboard, spaced apart from one another that project above a larger, major fingerboard surface. Each member of this series of structures has its axis of elongation provided transversely to the major axis of the neck, and each is located at a precise location along the length of the fingerboard.

The purpose of these frets is to permit the individual playing the instrument to shorten the effective length of the vibrating portion of a string positioned thereover. The individual or musician is enabled to select the effective lengths of the string at precise points, each of which is determined using the fret chosen by the musician for this purpose, to thereby alter the pitch or frequency of the sound produced by the vibrating string. If the individual stops the string against the fingerboard major surface on the side of the fret opposite the bridge or saddle, the string will also be stopped against that fret and a precise vibration frequency in the string can thus be set determined by the distance of the fret from the bridge or saddle. Frets promote the facility of playing the correct or perfect pitch, however they impede the smooth on changing musical notes occurred in a fretless fingerboard.

In fretless fingerboard, the string is stopped against the fingerboard surface by the musician wherever the individual chooses, and the resulting vibration frequency of that portion of the string between this stop point and the bridge or saddle is determined by the precise position of the point at which the string is stopped. Hence, there is no fret to stop the string against to provide a corresponding fixed frequency of vibration of string and the vibration frequency will change slightly with slight shifts in the stop point chosen by the placement of the musician's finger. Consequently, the point at which the string is stopped in a fretless fingerboard is more critical in determining the resulting vibration frequency of the string than is the point at which it is stopped in a fretted fingerboard, the latter requiring only that the string be stopped behind the fret to give a known frequency associated with that fret. Thus, a large range of frequencies for a vibrating string can be selected by a musician playing a fretless fingerboard than can be selected by a musician playing a fretted fingerboard. However, there is a large difficulty degree forming the correct or perfect pitch in a fretless fingerboard.

Instruments are available which have marks in substitution at every fret on the fingerboard. There is no difference between a regular fretless fingerboard and the fingerboard referred above.

There is further the need for a fretless fingerboard that allows the musician the flexibility to play an instrument without frets however with its sound characteristics and maintaining the facilities provided by a fretted fingerboard. This invention provides the solution for this need.

### SUMMARY

The invention relates to a device to allow a fretless stringed musical instrument to be played with the same facilities of a fretted stringed musical instrument without losing the fretless instrument characteristics.

Accordingly, several objects and advantages of the present invention are:

(a) to provide the characteristics of a fretless instrument and also the characteristics of a fretted instrument in a single fingerboard;

(b) to provide to the musician to play chords almost impossible to be played in an instrument without frets;

(c) to provide to the musician an easier method or way to form the correct or perfect pitch at an instrument without frets.

### BRIEF DESCRIPTION OF THE DRAWINGS

FIG. 1 is a plain view showing a guitar.

FIG. 2 is a sectional view, along Section 2-2 of FIG. 1.

### REFERENCE NUMERAL IN DRAWINGS

10 guitar

12 grooves

14 neck

16 fingerboard

18 head

20 strings

22 bridge

24 body

### DETAILED DESCRIPTION OF THE INVENTION

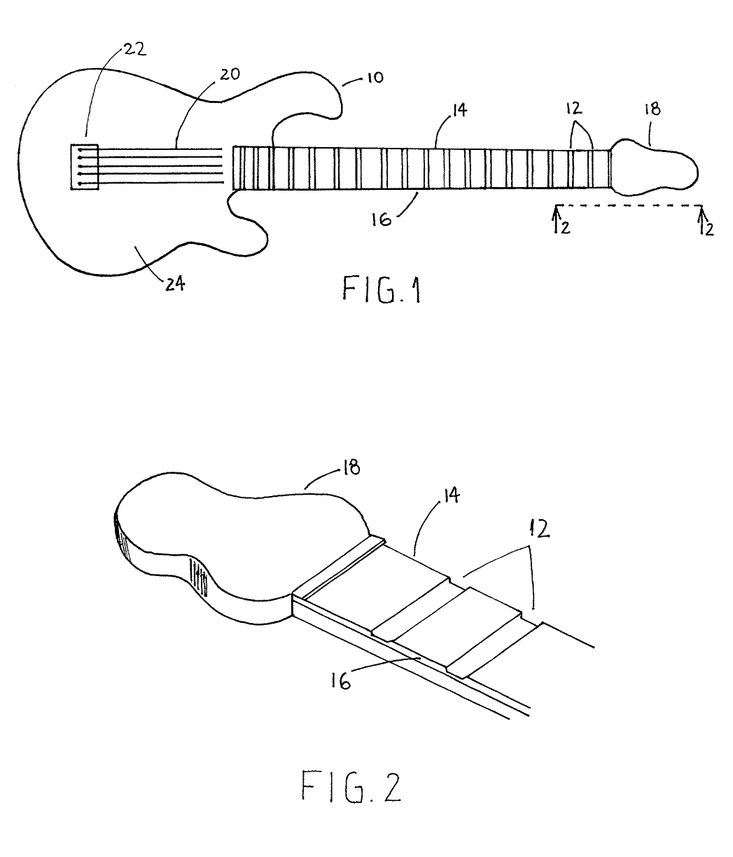

Referring to FIG. 1, illustrates a guitar generally designated by reference numeral 10 and emboding the invention. As seen in this FIG., a guitar 10 comprises a body 24, a neck 14, a fingerboard 16 within a plurality of grooves 12 are located, a head 18, series of strings 20, and a bridge 22.

Referring to FIG. 2, a portion of a guitar 10 neck 14 is shown. The fingerboard 16 is seen to include a plurality of grooves 12 each at the proper location to provide the appropriate musical pitch for the instrument. Each of the grooves 12 are seen to be disposed transversely with respect to the longitudinal dimension of the fingerboard 16 as indicated by the direction of the strings 20.

These series of grooves 12 are the main point of the invention. In this invention, when the string 20 is stopped by the musician against the space between two grooves 12, the fingerboard 16 works as a fretless fingerboard 16 providing a considerably wider range of frequencies. And if the string 20 is stopped inside of any groove 12, against its edge (the edge in the direction of the bridge), this groove 12 will work as the same function as a fret, providing a known frequency associated with the position of that specific groove 12.

The grooves 12 may be made in any format or shape and each being located at a different predetermined distance from bridge 22 to provide a given tonal scale. At the experiments with the prototypes of the invention the distance between the transverse edges of each groove 12 is 3 mm and has a depth of 2 mm. Those dimensions are variable in accordance with a predetermined fingerboard 16. The grooves could be routed, carved, punctured, opened using any abrasive method or any other method which would provide a predetermined groove 12.

While the above provides a full and complete disclosure of the preferred embodiments of the invention, various modifications, alternate constructions and equivalents may be employed without departing from the true spirit and scope of the invention. Therefore the above description and illustrations should not be construed as limiting the scope of the invention which is defined by the appended claims.

I claim:

1. A device for tuning stringed musical instruments comprising:
(a) a fingerboard having a plurality of predetermined grooves each located at a precise location in accordance with a predetermined tonal scale;
(b) said plurality of predetermined grooves having the same function of regular frets on said fingerboard.
(c) said plurality of predetermined grooves disposed transversally with respect to the longitudinal dimension of said fingerboard.
